(19) United States
(12) Patent Application Publication
(10) Pub. No.: US 2011/0022302 A1
(43) Pub. Date: Jan. 27, 2011

(54) NAVIGATION DEVICE

(76) Inventor: Hiroshi Machino, Tokyo (JP)

Correspondence Address: BIRCH STEWART KOLASCH & BIRCH, PO BOX 747, FALLS CHURCH, VA, 22040-0747, US

(21) Appl. No.: 12/866,815

(22) PCT Filed: Mar. 5, 2009
(86) PCT No.: PCT/JP2009/000997

§ 371 Date: Aug. 9, 2010

(30) Foreign Application Priority Data
Apr. 28, 2008 (JP) 2008-117422

(51) Int. Cl. G01C 21/36

(52) U.S. Cl. 701/201; 701/200

(57) ABSTRACT

A navigation device includes a map data storage unit 12 for storing a flag created on the basis of map data and including only information required to perform a navigation function, and a control unit 10 for reading the flag from the map data storage unit to perform the navigation function by using the flag read thereby.

### FIELD OF THE INVENTION

The present invention relates to a navigation device that guides a user to his or her destination. More particularly, it relates to a technology of efficiently performing a navigation function such as a route search or route guidance.

### BACKGROUND OF THE INVENTION

A related art navigation device displays a map on a display unit while superimposing the current position of a vehicle determined by a vehicle position calculation unit on the map. The related art navigation device also carries out a route search process of searching for a recommended route leading to the destination via waypoints from the current position of the vehicle on the basis of map data, and displaying the recommended route on the map. The related art navigation device further carries out route guidance according to the recommended route acquired through the route search on the basis of data about road links included in a map database.

When performing the navigation function, such as a route search or route guidance, such the navigation device uses data including the width, road class, speed limit, etc. of each road included in the map database. In order to implement the navigation function, the navigation device then acquires a large amount of map data from the map database to perform the process. Therefore, a problem is that it takes much time for the navigation device to carry out the process.

In order to solve the problem, patent reference 1 discloses a map data creating device that can create map data which enables reduction in the data volume to be read in order to make a search for an optimal route. This map data creating device creates map data of layered structure having level 1 regions and level 2 regions which are layered, and an exclusive network corresponding to each combination of two level 2 regions. An upper layer transition search range rectangle generating unit of the map data creating device actually extends a search branch by focusing attention to one level 1 region to detect a route leading to an upper node included in either a level 2 region including this level 1 region or another level 2 region adjacent to the level 2 region, and creates map data which is associated with the level 1 region. An exclusive network generating unit creates map data including the results of having actually searched for a route connecting between two level 2 regions.

Furthermore, patent reference 2 discloses a navigation device that can search for an optimal route and that can also speed up its processing. In this navigation device, an upper layer transition search range rectangle specifying unit sets an upper layer transition search range rectangle which corresponds to each of the place of departure and the destination, and which enables an upper node search unit to reach an upper node in a level 2 region certainly when making a search within a level 1 region, and the upper node search unit extracts an upper node from within this upper layer transition search range rectangle. A route-between-upper-nodes searching unit searches for a route which connects between the upper nodes respectively corresponding to the place of departure and the destination, which are extracted by the upper node search unit, by using the exclusive network.

Furthermore, patent reference 3 discloses a navigation device that can reduce difference data amounts and that can carry out a differential update process easily. In this navigation device, a permanent link ID (permanent link ID) is attached to each object such as a link constructing a road, and each record in drawing data, route search data, and route guide data is described by using such a permanent link ID so as to construct map data. Difference data which are created from comparisons between old map data and new map data are inputted to the navigation device, and the navigation device updates the old map data to the new map data by using the old map data stored in a map record medium and the above-mentioned difference data inputted thereto.

[Patent reference 1] JP,2003-323112,A

[Patent reference 2] JP,2003-337034,A

[Patent reference 3] JP,2004-287705,A

A problem with the above-mentioned conventional technologies is, however, that the size of a program for implementing the navigation function becomes too large and this results in reduction of the processing capability, route information and guidance information cannot be provided for the user quickly. Another problem is that because the program becomes complicated, it takes much time to create the program while a fault occurs in the program frequently.

The present invention is made in order to solve the above-mentioned problems, and it is therefore an object of the present invention to provide a navigation device that can reduce its program size and that can enhance its processing capability.

### DESCRIPTION OF THE INVENTION

In order to solve the above-mentioned problems, a navigation device in accordance with the present invention includes a map data storage unit for storing a flag created on a basis of map data and including only information required to perform a navigation function, and a control unit for reading the flag from the map data storage unit to perform the navigation function by using the flag read thereby.

Because the navigation device in accordance with the present invention is configured in such a way as to perform a navigation function by using a flag including only information required to perform the navigation function, the navigation device does not have to read a large amount of map data directly from the map data storage unit to perform the navigation function. Therefore, because a program for implementing the navigation function can be simplified, the size of the program can be reduced while the processing capability of the program can be enhanced. As a result, the navigation device can provide the user with route information or guidance information quickly. Furthermore, because the program is simplified, the time required to create the program can be shortened, and the occurrence of faults in the program can be reduced.

### BRIEF DESCRIPTION OF THE FIGURES

FIG. 1 is a block diagram showing the structure of a navigation device in accordance with Embodiment 1 of the present invention;

FIG. 2 is a flow chart showing a main process carried out by the navigation device in accordance with Embodiment 1 of the present invention;

FIG. 3 is a view showing an example of a destination setting screen displayed by the navigation device in accordance with Embodiment 1 of the present invention;

FIG. 4 is a view showing an example of a search condition setting screen displayed by the navigation device in accordance with Embodiment 1 of the present invention;

FIG. 5 is a view showing a relationship between flags which are stored in a map data storage unit and an HOV function implemented by a control unit in the navigation device in accordance with Embodiment 1 of the present invention;

FIG. 6 is a view for explaining a HOV lane position shown by flags created by the navigation device in accordance with Embodiment 1 of the present invention; and

FIG. 7 is a flow chart showing a process of determining whether or not a vehicle can make an HOV lane change which is carried out by the navigation device in accordance with Embodiment 1 of the present invention.

### PREFERRED EMBODIMENTS OF THE INVENTION

Hereafter, the preferred embodiment of the present invention will be explained in detail with reference to the drawings.

### Embodiment 1

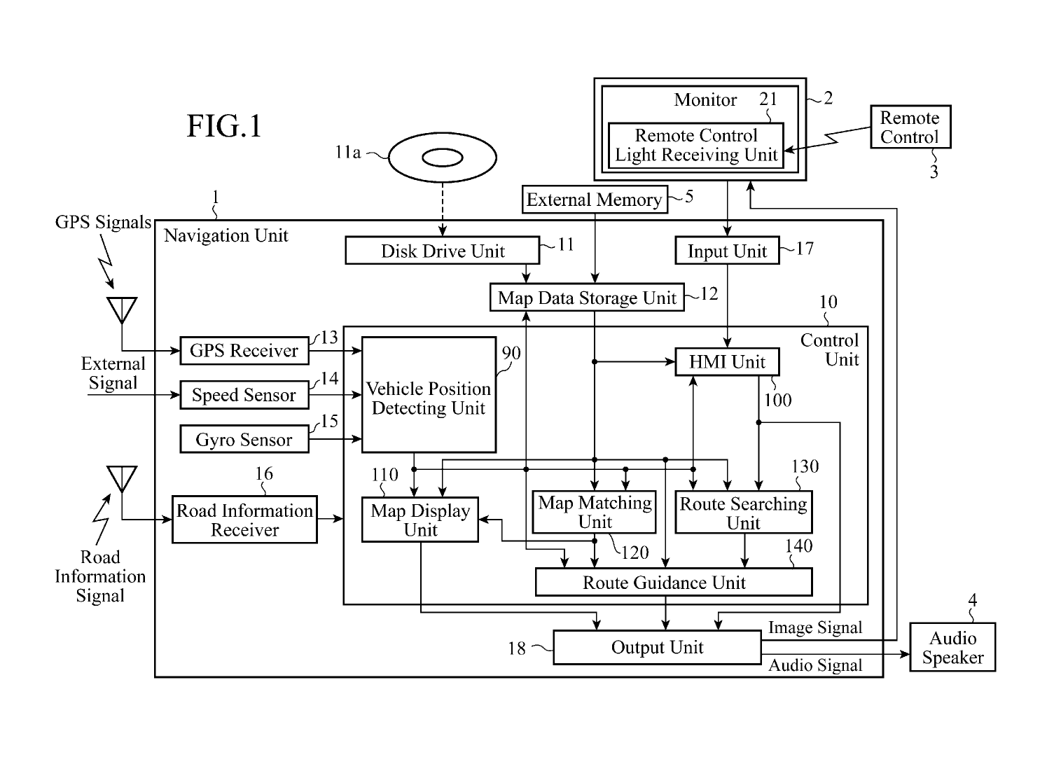

FIG. 1 is a block diagram showing the structure of a navigation device in accordance with Embodiment 1 of the present invention. This navigation device is comprised of a navigation unit 1, a monitor 2, a remote controller (abbreviated as a “remote control” from here on) 3, an audio speaker 4, and an external memory 5.

The navigation unit 1 forms the heart of this navigation device, and carries out program processes including display of a map, a route search, display of a route, and route guidance. The details of this navigation unit 1 will be mentioned below.

The monitor 2 is comprised of, for example, an LCD (Liquid Crystal Display), and displays a map, a vehicle position mark, a route to a destination, a route guidance view, and other various messages according to an image signal sent thereto from the navigation unit 1. A remote control light receiving unit 21 is disposed in this monitor 2. The remote control light receiving unit 21 receives a light signal sent thereto from the remote control 3, and sends the light signal to the navigation unit 1 as an input signal via the monitor 2.

The remote control 3 is used in order for a user to scroll a map displayed on the monitor 2, input a waypoint and a destination, and respond to a message for urging the user to perform a certain operation. Instead of the remote control 3 or together with the remote control 3, a touch panel can be disposed. The touch panel is comprised of a touch sensor placed on the screen of the monitor 2, and the user is allowed to directly touch this touch sensor to input various pieces of information to the navigation device.

The audio speaker 4 outputs, by voice, a route guidance message according to an audio signal sent thereto from the navigation unit 1. The external memory 5 is optional and is comprised of, for example, a memory card or a USB memory. Map data similar to map data stored in a recording medium 11a inserted into a disk drive unit 11 which will be mentioned below are stored in this external memory 5. Use of this external memory 5 makes it possible to access the map data at a high speed, as well as to store a lot of map data.

Next, the details of the navigation unit 1 will be explained. The navigation unit 1 is comprised of a control unit 10, the disk drive unit 11, a map data storage unit 12, a GPS (Global Positioning System) receiver 13, a speed sensor 14, a gyro sensor 15, a road information receiver 16, an input unit 17, and an output unit 18.

The control unit 10 is comprised of, for example, a microcomputer, and controls the whole of the navigation unit 1. The details of this control unit 10 will be mentioned below.

The disk drive unit 11 reproduces the recorded contents of the recording medium 11a, such as a DVD (Digital Versatile Disc) or a CD (Compact Disc), in which map data are recorded when the recording medium 11a is inserted thereinto. Data about nodes and road links, lane markers, etc. are defined in the map data (the data will be mentioned below in detail). Flags are data blocks which are extracted by collecting components required to perform each of navigation functions from components (data such as the widths, road classes and speed limits of roads) which construct the map data. The map data reproduced by this disk drive unit 11 and the flags are sent to the map data storage unit 12.

The map data storage unit 12 temporarily stores the map data sent thereto from the disk drive unit 11 or the external memory 5, and the flags. The map data and the flags stored in this map data storage unit 12 are referred to by the control unit 10. The map data storage unit 12 can be comprised of an HDD (Hard Disk Drive). In this case, the disk drive unit 11 and the external memory 5 become unnecessary.

The GPS receiver 13 detects the current position of the vehicle on the basis of GPS signals received, via an antenna, from GPS satellites. The current position of the vehicle detected by this GPS receiver 13 is informed to the control unit 10 as a current position signal. The speed sensor 14 detects the speed of the vehicle on the basis of an external signal sent thereto from the vehicle in which this navigation device is mounted. The speed of the vehicle detected by this speed sensor 14 is informed to the control unit 10 as a speed signal. The gyro sensor 15 detects the heading of the vehicle. The heading of the vehicle detected by this gyro sensor 15 is informed to the control unit 10 as a heading signal.

The road information receiver 16 receives a road information signal transmitted thereto from, for example, an external road traffic data communications system. The road information signal received by this road information receiver 16 is sent to the control unit 10. The control unit 10 creates a message showing the traffic congestion conditions of roads on the basis of the road information signal sent thereto from this road information receiver 16, and notifies the message to the user by outputting the message via the monitor 2 and the audio speaker 4.

The input unit 17 receives and analyzes an input signal sent thereto, via the remote control light receiving unit 21, from the remote control 3, and sends the results of this analysis to the control unit 10 as an operation command. The input unit 17 can be configured in such a way as to include a voice recognition function of recognizing an audio signal sent thereto from a not-shown microphone, analyze the results of the voice recognition performed by this voice recognition function, and send the results of this analysis to the control unit 10 as an operation command.

The output unit 18 creates an image signal on the basis of both drawing data for drawing a map, a vehicle position mark and a route and the operation command, which are sent thereto from the control unit 10, and also creates an audio signal on the basis of audio data sent thereto from the control unit 10. The image signal created by this output unit 18 is sent to the monitor 2. Furthermore, the audio signal created by the output unit 18 is sent to the audio speaker 4.

Next, the details of the control unit 10 will be explained. The control unit 10 is comprised of a vehicle position detecting unit 90, a human-machine interface (abbreviated as “HMI” from here on) unit 100, a map display unit 110, a map matching unit 120, a route searching unit 130, and a route guidance unit 140. These components can consist of an application program that operates under the control of a microcomputer.

The vehicle position detecting unit 90 detects the current position of the vehicle on the basis of the current position signal sent thereto from the GPS receiver 13, and also detects the current position of the vehicle through dead reckoning on the basis of both the speed signal sent thereto from the speed sensor 14, and the heading signal sent thereto from the gyro sensor 15. Because the vehicle position detecting unit can detect the current position of the vehicle through dead reckoning even if the GPS receiver 13 cannot receive GPS signals when, for example, the vehicle is travelling through a tunnel or the like, the navigation device can always detect the current position of the vehicle correctly. Current position data showing the current position of the vehicle detected by this vehicle position detecting unit 90 are sent to the HMI unit 100, the map display unit 110, the map matching unit 120, the route searching unit 130, and the route guidance unit 140.

The HMI unit 100 processes the operation command sent thereto from a not-shown operation panel or the input unit 17 by using both the map data sent thereto from the map data storage unit 12 and the current position data sent thereto from the vehicle position detecting unit 90. This HMI unit 100 carries out communications between the navigation device and the user. The operation command processed by the HMI unit 100 is sent to the route searching unit 130 and the output unit 18.

The map display unit 110 reads map data about an area surrounding the position shown by the current position data sent thereto from the vehicle position detecting unit 90 from the map data storage unit 12, and creates drawing data for displaying a map on the screen of the monitor 2 on the basis of this read map data and the data showing the vehicle position mark sent from the map matching unit 120. The drawing data created by this map display unit 110 are sent to the output unit 18.

The map matching unit 120 matches the vehicle position shown by the current position data sent thereto from the vehicle position detecting unit 90 with the map shown by flags which are created to implement a map matching function and are read from the map data storage unit 12 so as to form the vehicle position mark to be superimposed on the map. Data showing the vehicle position mark formed by the map matching unit 120 are sent to the map display unit 110 and the route guidance unit 140.

The route searching unit 130 searches for an optimal route leading from the current position of the vehicle shown by the current position data sent thereto from the vehicle position detecting unit 90 to the destination (sent via the following path: the remote control 3→the remote control light receiving unit 21→the input unit 17→the HMI unit 100) set by using the remote control 3 according to the search conditions set by using the remote control 3 and on the basis of the flags which are created to implement the map matching function and are read from the map data storage unit 12. Route data showing the route which has been searched for by this route searching unit 130 are sent to the route guidance unit 140.

The route guidance unit 140 creates both drawing data for displaying a route guidance view, such as route guidance outputted as the vehicle travels, on the screen of the monitor 2 and audio data for outputting a route guidance message, such as guidance about intersections, via voice on the basis of the current position data sent thereto from the vehicle position detecting unit 90, the data showing the vehicle position mark sent thereto from the map matching unit 120, the route data sent thereto from the route searching unit 130 and the flags which are created to implement the map matching function and is read from the map data storage unit 12, and sends the drawing data and the audio data to the output unit 18.

The output unit 18 creates an image signal on the basis of the drawing data for drawing the map which are sent thereto from the map display unit 110 of the control unit 10, the drawing data for drawing the vehicle position mark and the route which are sent thereto from the route guidance unit 140, and the operation command sent thereto from the HMI unit 100, as mentioned above, and also creates an audio signal on the basis of the audio data sent thereto from the route guidance unit 140 of the control unit 10.

Next, the operation of the navigation device in accordance with Embodiment 1 of the present invention configured as mentioned above will be explained by taking, as an example, a case in which the navigation device is applied to a road system which will be explained below.

Recent years have seen increase in the number of cars owned by individuals and occurrence of traffic congestions in various parts of roads. Particularly, a highway or a motorway leading to a big city which is used by people who commute to and from offices is occupied by vehicles in most of which only one person gets, and this results in increases in traffic congestion. In order to solve this problem, there have been constructed highways where traffic is restricted by law according to the conditions of vehicles including the number of passengers and vehicle types.

For example, a car pool lane (Car Pool Lane) or the like which is used for a road system which is mainly seen in North American big cities and so on. A car pool lane is also called an HOV lane (High Occupancy Vehicle Lane), and is a lane along which, for example, only vehicles in each of which two or more persons are riding are granted to travel. For example, a lane which is also provided on a highway is known as a carpool lane. A road system which adopts such a car pool lane provides users with a preferential treatment that makes it possible to arrive at the destination in a shorter time as long as they travel along a car pool lane so as to prod users to share a vehicle with one or more persons, thereby reducing the traffic as a whole and therefore reducing traffic congestions.

In this specification, a navigation function regarding HOV lanes (car pool lanes) is called an HOV function. The HOV function includes an HOV map matching function implemented by the map matching unit 120, an HOV route searching function implemented by the route searching unit 130, and an HOV route guidance function implemented by the route guidance unit 140.

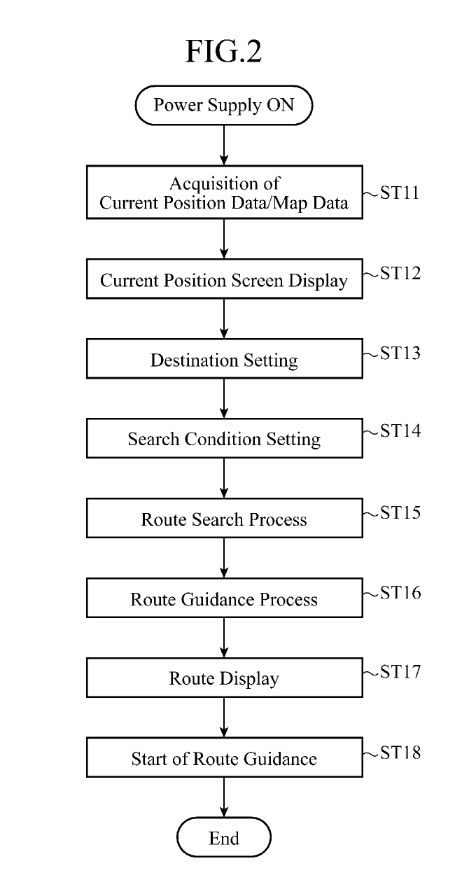

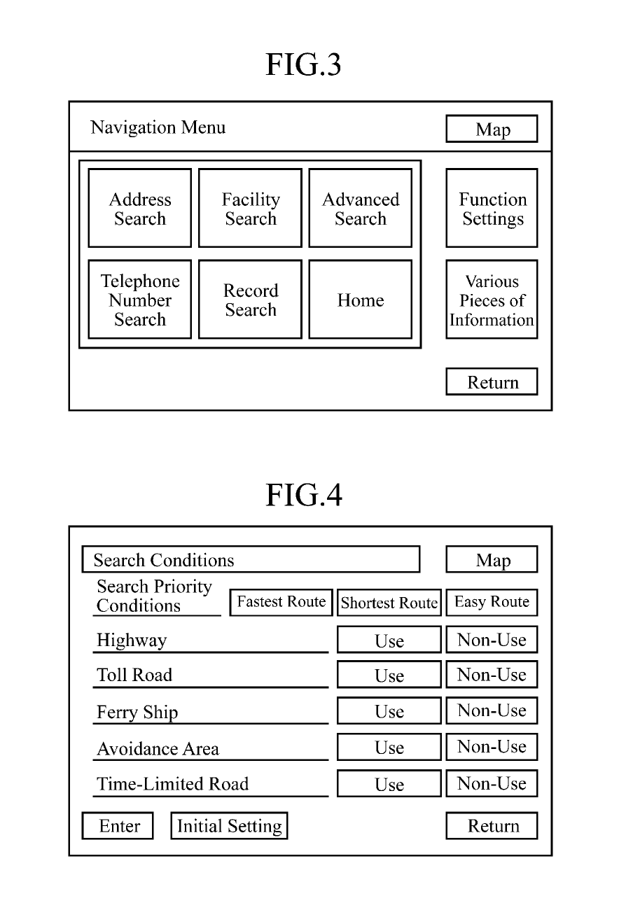

A main process carried out with this navigation device will be explained with reference to a flow chart shown in FIG. 2, and examples of the screen shown in FIGS. 3 and 4. In this main process, processes including a setting of the place of departure, the destination, and waypoints, a route search, start of route guidance are mainly carried out. Hereafter, the main process will be concretely explained.

In the main process, when the power supply is turned on, the current position data and map data are acquired first (step ST11). More specifically, the vehicle position detecting unit 90 sends either the current position of the vehicle which the vehicle position detecting unit has detected on the basis of the current position signal sent thereto from the GPS receiver 13, or the current position of the vehicle which the vehicle position detecting unit has detected by using both the speed signal sent thereto from the speed sensor 14 and the heading signal sent thereto from the gyro sensor 15 through dead reckoning to the map matching unit 120 as current position data. The disk drive unit 11 reads map data and flags from the recording medium 11a set thereto, and stores them in the map data storage unit 12.

When receiving the current position data from the vehicle position detecting unit 90, the map matching unit 120 performs a matching process of matching the vehicle position shown by the current position data with the map shown by the flags which are created in order to implement the HOV map matching function and which are read from the map data storage unit 12. Through this matching process, the vehicle position mark is formed on the map. Data showing the vehicle position mark acquired through this matching process are sent to the map display unit 110 and the route guidance unit 140.

A display of a current position screen is then produced (step ST12). More specifically, the map display unit 110 reads map data about an area surrounding the position shown by the current position data sent thereto from the vehicle position detecting unit 90 from the map data storage unit 12, creates drawing data for displaying the map on the screen of the monitor 2 on the basis of this read map data and the data showing the vehicle position mark sent thereto from the map matching unit 120, and sends the drawing data to the output unit 18.

Furthermore, the route guidance unit 140 creates drawing data for displaying the vehicle position mark on the screen of the monitor 2 on the basis of the data showing the vehicle position mark sent thereto from the map matching unit 120, and sends the drawing data to the output unit 18. The output unit 18 creates an image signal on the basis of the drawing data received from the map display unit 110 and the drawing data received from the route guidance unit 140, and sends the image signal to the monitor 2. The monitor 2 displays, as the current position screen, the map on which the vehicle position mark is superimposed, the map's center corresponding to the current position of the vehicle, on the basis of the image signal sent thereto from the output unit 18.

A setting of a destination is then performed (step ST13). More specifically, when the user performs an operation of commanding the navigation device to set a destination by using the remote control 3, the navigation device displays a destination setting screen as shown in FIG. 3 on the monitor 2. In this destination setting screen, a portion enclosed by a rectangle is a button, and the user is enabled to push down a desired button by using the remote control 3 to make the navigation device carryout a function allocated to the desired button. The same goes for each screen which will be explained hereafter.

The user sets a destination and a waypoint on the map currently displayed on the monitor 2 by using the remote control 3 to select address search, facility search, or telephone number search. In this case, the user can set a plurality of waypoints. Data showing the destination and the waypoints which are set by using the remote control 3 are sent to the route searching unit 130 via the input unit 17 and the HMI unit 100 of the navigation unit 1.

A setting of search conditions is then performed (step ST14). More specifically, when a setting of a destination in step ST13 is completed, the navigation device displays a search condition setting screen as shown in FIG. 4 on the monitor 2. The user then sets conditions for route search which are displayed on the monitor 2 by using the remote control 3. Concretely, the user sets a higher-priority search condition by pushing one of a button showing “fastest route”, a button showing “shortest route”, and a button showing “easy route”, the buttons showing higher-priority conditions respectively. The user also sets whether the navigation device can use each of the following items: a highway, a toll road, a ferry ship, an avoidance route area, and a time-limited road by pushing down a “use” button or a “non-use” button.

A “map” button in the search condition setting screen shown in FIG. 4 is used in order to return the screen of the monitor 2 to the current position screen, an “enter” button is used in order to make the settings permanent, an “initial setting” button is used in order to return the search conditions to initial ones, and a “return” button is used in order to return the screen of the monitor to the previous screen. When the “enter” button in this search condition setting screen is pushed down, data showing the set search conditions are sent to the route searching unit 130 via the input unit 17 and the HMI unit 100 of the navigation unit 1.

A route search process is then carried out (step ST15). More specifically, the route searching unit 130 searches for a route leading from the current position shown by the current position data received from the vehicle position detecting unit 90, via the waypoints set in step ST13, to the destination according to the search conditions set in step ST14 and on the basis of the flags which are created to implement the map matching function and are read from the map data storage unit 12. Route data showing the route which has been searched for by this route searching unit are sent to the route guidance unit 140.

A route guidance process is then carried out (step ST16). More specifically, the route guidance unit 140 creates both drawing data for displaying a route guidance view on the screen of the monitor 2 and audio data for outputting a route guidance message via voice on the basis of the current position data sent thereto from the vehicle position detecting unit 90, the data showing the vehicle position mark sent thereto from the map matching unit 120, the route data sent thereto from the route searching unit 130 and the flags which are created to implement the map matching function and are read from the map data storage unit 12, and sends the drawing data and the audio data to the output unit 18.

A route display screen is then produced (step ST17). More specifically, the output unit 18 creates an image signal on the basis of the drawing data for drawing the map sent thereto from the map display unit 110 of the control unit 10 and the drawing data for drawing the route and the vehicle position which are sent thereto from the route guidance unit 140. The image signal created by this output unit 18 is sent to the monitor 2. Accordingly, the guidance route and route guidance are displayed on the monitor 2. In this state, after the user checks that the route displayed on the monitor 2 is the one which the user has desired, he or she commands the navigation device to start guidance by pushing down a button (not shown) disposed on the screen of the monitor 2 or uttering a phrase.

Route guidance is then started (step ST18). More specifically, after the guidance start command is outputted in step ST17, the navigation device starts route guidance. More specifically, the output unit 18 creates an image signal on the basis of the drawing data for drawing the map sent thereto from the map display unit 110 of the control unit 10 and the drawing data for drawing the route and the vehicle position which are sent thereto from the route guidance unit 140, and also creates an audio signal on the basis of the audio data sent thereto from the route guidance unit 140 of the control unit 10. The image signal created by this output unit 18 is sent to the monitor 2. Accordingly, the guidance route and route guidance are displayed on the monitor 2. Furthermore, the audio signal created by the output unit 18 is sent to the audio speaker 4. Accordingly, the route guidance message is outputted from the audio speaker 4. After that, because the route guidance message corresponds to the environment which varies as the vehicle travels and is outputted in turn, the user can drive the vehicle according to the route guidance.

Next, in order to deepen the understanding of the navigation device in accordance with Embodiment 1 of the present invention, the flags will be further explained in detail.

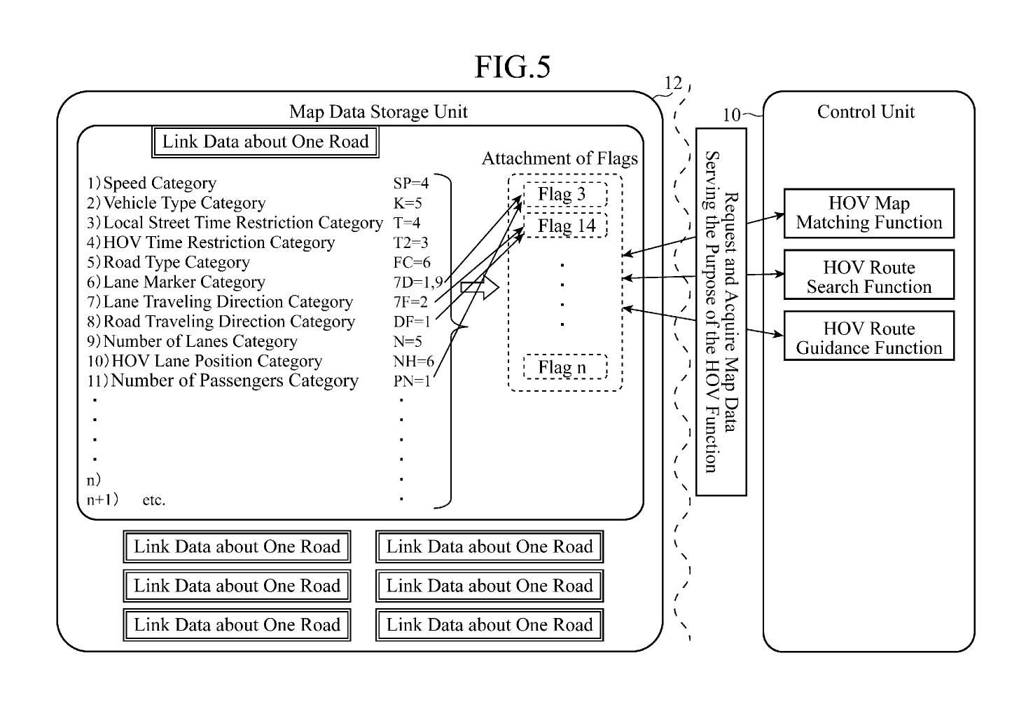

FIG. 5 is a view showing a relationship between the map data and the flags which are stored in the map data storage unit 12, and the HOV function implemented by the control unit 10. For example, the HOV map matching function implemented by the map matching unit 120 includes the step of, when acquiring data about road links required to perform the map matching process, acquiring the flags which are created by collecting the data required to perform the map matching process in advance, instead of acquiring the data required to perform the map matching process from a huge number of categories included in the data about the road links. The same goes for a case of performing the HOV route search function implemented by the route searching unit 130, and a case of performing the HOV route guidance function implemented in the route guidance unit 140.

Hereafter, the explanation will be made by providing a concrete example. Hereafter, flags used for a determination of whether or not the vehicle can make a lane change which is carried out during a process for implementing the HOV route search function and the HOV route guidance function will be explained. In the following explanation, “attachment of flag” means that when a road link has data meeting the conditions shown by a flag, the flag is attached to the road link.

First, it is assumed that data about each road link includes the following categories (only a part of them is shown).

(1-1) Number of passengers (NP) information

0: No number (any number of passengers is not specified)

1: More than 2 persons (two or more passengers have to ride)

(1-2) Lane marker (7D) information

0: No marker (no marking line)

1: Long Dashed Line (long dashed line)

2: Double Solid Line (double solid line)

3: Single Solid Line (single solid line)

4: Double Line, combination of inner single solid line and outer dashed Line (double line, combination of inner single solid line and outer dashed line)

5: Double Line, combination of inner dashed line and outer single solid Line (double line, combination of inner dashed line and outer single solid line)

6: Short Dashed Line (short dashed line)

7: Shared Area Marking (shared area marking)

8: Dashed Blocks (marker with blocks)

9: Physical Divider (physical marker)

10: Double dashed line (double dashed line)

(1-3) Traffic road traveling direction (DF) information

1: Open in both directions (allowed to travel in both directions)

2: Open in Positive directions (allowed to travel in a south to north direction only)

3: Open in Negative directions (allowed to travel in a north to south direction only)

4: Closed in both directions (not allowed to travel in both directions)

(1-4) Traffic each lane traveling direction (7F) information

1: Open in both directions (allowed to travel in both directions)

2: Open in Positive directions (allowed to travel in a south to north direction only)

3: Open in Negative directions (allowed to travel in a north to south direction only)

4: Closed in both directions (not allowed to travel in both directions)

(1-5) HOV lane position (R) information

1: HOV lane running at right end

2: HOV lane running at right end or center

3: HOV lane running at left end

4: HOV lane running at left end or center

5: HOV lane running at position other than right end, left end, and center

For example, data about a road link includes the following information: NP=1, 7D=4&8, DF=3, and . . . .

One of flags 0 to 3 is attached to each road link as the following conditions.

Flag 0: Lane marker via which vehicles are allowed to enter or exit an HOV lane or a general lane.

Flag 1: Lane marker via which vehicles are allowed to only exit an HOV lane into a general lane.

Flag 2: Lane marker via which vehicles are allowed to only exit a general lane into an HOV lane.

Flag 3: Lane marker via which vehicles are not allowed to enter and exit any of an HOV lane and a general lane.

According to which type of lane marker (7D) or a combination of some of the types each road link has, one of the above-mentioned flags 0 to 3 is attached to each road link as follows.

(2-1) Attachment of flag according to the type of lane marker (7D) in the case of the number of passengers NP=1.

0: No marker “flag 0”

1: Long Dashed Line “flag 0”

2: Double Solid Line “flag 3”

3: Single Solid Line “flag 3”

4: Double Line, combination of inner single solid line and outer dashed Line

“flag 1” or “flag 2” according to on which side of the lane marker an HOV lane is running

5: Double Line, combination of inner dashed line and outer single solid Line

“flag 1” or “flag 2” according to on which side of the lane marker an HOV lane is running

6: Short Dashed Line “flag 0”

7: Shared Area Marking “flag 3”

8: Dashed Blocks “flag 0”

9: Physical Divider “flag 3”

10: Double dashed line “flag 0”

(2-2) One of the flags 0 to 3 is also attached to each of a plurality of combinations of types of lane markers (7D) in the case of the number of passengers NP=1. In the case of the lane marker 7D information=1&9, a combination of “flag 0” and “flag 3” is provided, and this combination is defined as “flag 3”.

Furthermore, a combination of “flag 0” and “flag 0” is defined as “flag 0”,

a combination of “flag 0” and “flag 1” is defined as “flag 1”,

a combination of “flag 0” and “flag 2” is defined as “flag 2”,

a combination of “flag 0” and “flag 3” is defined as “flag 3”,

a combination of “flag 1” and “flag 1” is defined as “flag 1”,

a combination of “flag 1” and “flag 2” is defined as “flag 3”,

a combination of “flag 1” and “flag 3” is defined as “flag 3”,

a combination of “flag 2” and “flag 2” is defined as “flag 2”,

a combination of “flag 2” and “flag 3” is defined as “flag 3”, and

a combination of “flag 3” and “flag 3” is defined as “flag 3”.

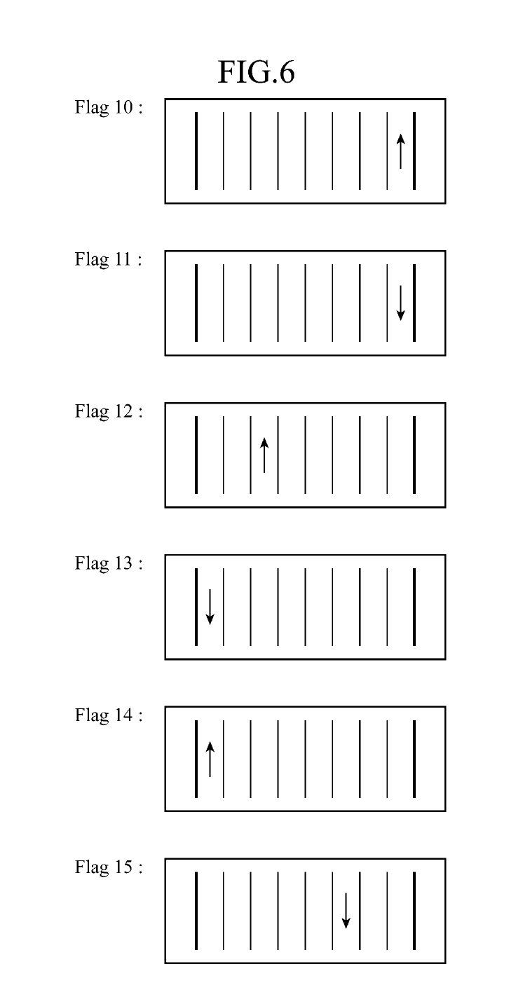

One of flags 10 to 15 showing conditions as will mentioned below respectively is attached to data about each road link. An HOV lane position shown by each of the flags is shown in FIG. 6.

Flag 10: either traffic road traveling direction (DF) information=1 and traffic each lane traveling direction (7F) information=2, or traffic road traveling direction (DF) information=2, and lane position R information=1.

Flag 11: either traffic road traveling direction (DF) information=1 and traffic each lane traveling direction (7F) information=3, or traffic road traveling direction (DF) information=3, and lane position R information=2.

Flag 12: either traffic road traveling direction (DF) information=1 and traffic each lane traveling direction (7F) information=2, or traffic road traveling direction (DF) information=2, and lane position R information=5.

Flag 13: either traffic road traveling direction (DF) information=1 and traffic each lane traveling direction (7F) information=3, or traffic road traveling direction (DF) information=3, and lane position R information=3.

Flag 14: either traffic road traveling direction (DF) information=1 and traffic each lane traveling direction (7F) information=2, or traffic road traveling direction (DF) information=2, and lane position R information=4.

Flag 15: either traffic road traveling direction (DF) information=1 and traffic each lane traveling direction (7F) information=3, or traffic road traveling direction (DF) information=3, and lane position R information=5.

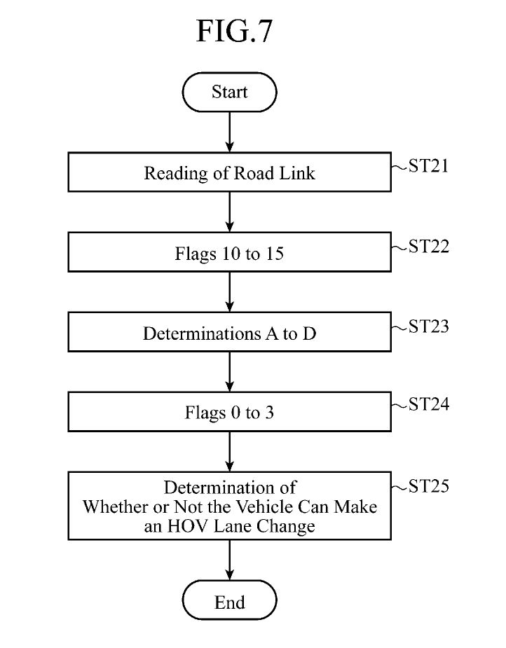

The process of carrying out a determination of whether or not the vehicle can make an HOV lane change in performing either the HOV route search function or the HOV route guidance function by using the flags 10 to 15 and the flags 0 to 3 which are created as mentioned above will be explained with reference to a flow chart shown in FIG. 7.

First, a road link is read (step ST21). More specifically, either the route searching unit 130 or the route guidance unit 140 reads data of a road link from the map data storage unit 12. One of the flags 10 to 15 is then acquired (step ST22). More specifically, either the route searching unit 130 or the route guidance unit 140 acquires the flag attached to the road link read in step ST21.

One of determinations A to D is then carried out (step ST23). In this step ST23, a determination of whether or not the lane marker information has been read is carried out. One of the flags 0 to 3 is then acquired (step ST24). More specifically, either the route searching unit 130 or the route guidance unit 140 acquires the flag attached to the road link read in step ST21.

A determination of whether or not the vehicle can make an HOV lane change is then carried out (step ST25). In this step ST25, when one of the following conditions A to D is satisfied, either the route searching unit 130 or the route guidance unit 140 carries out a determination as shown in the corresponding one of the determinations A to D from the combination of the determination carried out in step ST23 and the flag acquired in step ST24.

Condition A: a combination of either one of the flags 0 to 3 and the flag 10 or a combination of either one of the flags 0 to 3 and the flag 11.

Determination A: on the condition which is one of the combinations, whether the vehicle can enter and exit the HOV lane in question is determined according to the value of the lane marker (7D) information about the lane on the left side of the HOV lane, and whether the vehicle can enter and exit each of the HOV lane in question and another lane (left-side) is determined according to the value of the lane marker (7D) information about each of the lanes on the left and right sides of the HOV lane.

Condition B: a combination of either one of the flags 0 to 3 and the flag 13 or a combination of either one of the flags 0 to 3 and the flag 14.

Determination B: on the condition which is one of the combinations, whether the vehicle can enter and exit the HOV lane in question is determined according to the value of the lane marker (7D) information about the lane on the right side of the HOV lane, and whether the vehicle can enter and exit each of the HOV lane in question and another lane (right-side) is determined according to the value of the lane marker (7D) information about each of the lanes on the left and right sides of the HOV lane.

Condition C: a combination of either one of the flags 0 to 3 and the flag 12.

Determination C: on the condition which is one of the combinations, whether the vehicle can enter and exit each lane is determined according to the value of the lane marker (7D) information about each of the lanes on the left and right sides of each lane.

Condition D: a combination of either one of the flags 0 to 3 and the flag 15.

Determination D: on the condition which is one of the combinations, whether the vehicle can enter and exit the HOV lane in question is determined according to the value of the lane marker (7D) information about each of the lanes on the left and right sides of the HOV lane, and whether the vehicle can enter and exit the lane on each of the left and right sides of the HOV lane in question is determined according to the value of the lane marker (7D) information about each of the lanes on the left and right sides of the lane.

Either the HOV route guidance function or the HOV route search function is performed on the basis of the results of the above-mentioned determination of whether or not the vehicle can make an HOV lane change, the results of the HOV route guidance function or the HOV route search function are outputted from the output unit 18.

As previously explained, because the navigation device in accordance with Embodiment 1 of the present invention is configured in such a way as to perform a navigation function by using a flag including only information required to perform the navigation function, the navigation device does not have to read a large amount of map data directly from the map data storage unit to perform the navigation function. For example, in a case in which the flag 10 is required, information including the traffic road traveling direction (DF) information, the traffic each lane traveling direction (7F) information, the HOV lane position (R) information, etc. has to be acquired from the map data if the flag 10 does not exist. In contrast, the navigation device in accordance with this embodiment has only to acquire the flag 10. Therefore, because the program for implementing the navigation function can be simplified, the size of the program can be reduced while the processing capability of the program can be enhanced. As a result, the navigation device can provide the user with route information or guidance information quickly. Furthermore, because the program is simplified, the time required to create the program can be shortened, and the occurrence of faults in the program can be reduced.

The navigation device in accordance with above-mentioned Embodiment 1 can be modified as follows. More specifically, the navigation device can be configured in such a way as to, when a change, such as an update, an addition, or a deletion (revision and abolition), is made to the map data via communications or using a DVD-ROM, make a change, such as an update, an addition, or a deletion (revision and abolition), to the data in each flag through automatic creation or a manual operation.

Furthermore, the navigation device can be configured in such a way as to, when a new function is introduced into the navigation device as a navigation function, make the map data storage unit 12 store a flag which is created by collecting a component required to perform this introduced new function from the components which construct the map data.

In addition, the navigation device can be configured in such a way as to, when a function already existing as a navigation function is deleted from the navigation device, assume the flag required to perform this deleted function to be an unnecessary flag to delete the flag from the map data storage unit 12.

Furthermore, the navigation device can be configured in such a way as to collect a component required to perform a function other than a navigation function, e.g., an audio function, a video image function, or a communications function from the components which construct the map data to create a flag.

In addition, the navigation device can be configured in such a way as to, when a new function other than a navigation function is introduced into the navigation device as a navigation function, make the map data storage unit 12 store a flag which is created by collecting a component required to perform this introduced new function from the components which construct the map data.

Furthermore, the navigation device can be configured in such a way as to, when an existing function other than a navigation function is deleted from the navigation device, assume the flag required to perform this deleted function to be an unnecessary flag to delete the flag from the map data storage unit 12.

### INDUSTRIAL APPLICABILITY

As mentioned above, because the navigation device in accordance with the present invention is configured in such a way as to perform a navigation function by using a flag including only information required to perform the navigation function in order to reduce the program size and enhance the processing capability, thereby being able to quickly provide the user with route information or guidance information, the navigation device in accordance with the present invention is suitable for use as a navigation device that efficiently performs a navigation function such as a route search or route guidance.

1. A navigation device comprising:
a map data storage unit for storing map data and a flag created in advance on a basis of said map data and including only information required to perform a navigation function; and
a control unit for, instead of reading said map data directly from said map data storage unit to perform said navigation function, reading the said flag from said map data storage unit to perform said navigation function by using said flag read thereby.

2. The navigation device according to claim 1, wherein the flag is created by collecting a component required to perform the navigation function including a route search function and a route guidance function from components which construct the map data.

3. The navigation device according to claim 1, wherein the map data storage unit stores a flag which is created by collecting a component required to perform a route search function and a route guidance function which use car pool lanes from components which construct the map data, and the control unit reads the flag from said map data storage unit and performs either the route search function or the route guidance function which uses car pool lanes by using said flag read thereby.

4. The navigation device according to claim 1, wherein the flag stored in the map data storage unit is changed according to a change in the map data.

5. The navigation device according to claim 1, wherein when a new function is introduced as a navigation function, a flag which is created by collecting a component required to perform said new function from components which construct the map data is stored in the map data storage unit.

6. The navigation device according to claim 1, wherein when a function which already exists as a navigation function is deleted, a flag required to perform said deleted function is deleted from the map data storage unit.

7-9. (canceled)
